(19) United States
(12) Patent Application Publication
(10) Pub. No.: US 2009/0234735 A1
(43) Pub. Date: Sep. 17, 2009

(54) Methods for network-based groups related to digital media content

(76) Inventor: Jill Lewis Maurer, Raleigh, NC (US)

Correspondence Address: TRIANGLE PATENTS, P.L.L.C., P.O. BOX 28539, RALEIGH, NC, 27611-8539, US

(21) Appl. No.: 12/075,659

(22) Filed: Mar. 13, 2008

(51) Int. Cl. G06Q 30/00

(52) U.S. Cl. 705/14

(57) ABSTRACT

A system and methods for creating and joining groups of authorized users having at least one interest in common based upon user profile and/or user content index activities and preferences. The methods further provide for promotional material that is personalized to the groups, including automatic geographic alerts to groups, wherein the promotional material associated with digital media provided through a website for providing distribution and promotion for the digital content through network-based access to authorized users who pay for predetermined rights.

### BACKGROUND OF THE INVENTION

1. Field of the Invention

The present invention relates generally to network-based groups related to digital media content creation and distribution. Further, the present invention relates to the methods for creating and joining groups associated with digital media creation, upload, download, and rights acquisition by users of a network-based system.

2. Description of the Prior Art

Historically, music and entertainment was provided solely in a live format, wherein the audience only had real-time, live access to the performance. If someone wanted to access the music and entertainment, one had to travel to be in person for the performance. If payment was required, it would be on a pay-per-attendance basis made at the time the performance was rendered. Still music, plays, readings and other performances were documented on paper and issues of copyright infringement or plagiarism were relevant and problematic, in particular being difficult to monitor and police. Early and distributed release of the documented music by the actual or true author was one possible solution to these problems, although far from completely addressing the issues.

Later, music companies or record labels were established to manage the release and distribution of music and other entertainment. Publishing companies were similarly situated to manage written works, including texts, art, and the like. While distribution of the music and entertainment improved, the selection and timing of release was made by the third party companies, rather than by the artist or the consumer. So many talented artists and authors created works that were still nearly impossible to distribute or promote, in particular beyond time and geographic constraints. Recording and producing the music and entertainment, including digital mastering, was essentially controlled and managed by a few companies, rather than the artists and authors. Artists are paid very small fees, usually less than 10% of revenue from sales. Most of the ownership rights or copyrights were required to be assigned to the companies rather than being retained by the authors in exchange for the selective distribution, which frequently resulted in artistic compromise or censorship.

While some Internet websites like iTunes at www.apple.com/itunes provide for on-demand download to users having accounts who pay for rights to download copies, these sites do not provide for the user to play or download to a multiplicity of devices, with the exception of backup copies. Users can selectively access content they want, buying on a per-song or per-album basis, and similarly on a per-book or per-movie basis. While this scenario and business model improves distribution and helps to avoid some of the illegal downloading by making access to content affordable, the costs are still expensive and comparable to traditional recording industry standards for purchasing a copy of the content on a CD or DVD format (where you buy the DVD or CD with a copy of the content, but you don't actually own the content, for example if the DVD or CD is damaged or stolen, you don't get a free replacement for the copy you already purchased). iTunes provides for a user to download music, movies, audio books, and the like into a library that must be stored on the user's computer. iTunes does not retain the library for each user on its site; thus, if anything is lost or damaged or the computer is stolen, the library and the valuble content on it are no longer accessible by the user who rightfully owns that content, based on the licenses purchased.

Another website with content available through the Internet is youTube at www.youtube.com; it provides free content for play by any user on the site, and that free content is uploaded without review or confirmation of authorship or rights ownership, much less screened for quality or interest by users.

In both of the aforementioned cases, users can provide feedback or rating of the content. And the content may be categorized by subject or genre or artist. To some limited extent, it may also be searched through the website.

The Internet and web-based media distribution, along with the improvement of electronic devices for creating digital representations of works, has changed the entertainment scene; however, the industry—especially music, movies, and broadcast media (perhaps with the exception of XM radio)—has not significantly changed the business model for providing digital entertainment content to authorized users. The traditional industry position has held that its position is based on the protection of copyrights and other intellectual property; in fact, copyright infringement and illegal downloading have been problematic for a long, long time. The Internet alone has not addressed the problem of providing diverse, on-demand content to authorized users at reasonable rates, while providing reasonable compensation to artists and authors for participating in a structured, managed format.

Network-based or online interest groups or communities are known in the art. Typically, these groups are established for the purposes of information-sharing, discussion, or interaction among group members sharing at least one area of common interest. Other virtual groups are created unintentionally, but are created by users of websites, software, or other internet-based tools, where the focus of the group is problem-solving, information-sharing, evolving or developing content collaboratively, etc. With respect to digital media content distribution on a network, such as the Internet, there are a number of distributed sites, but these are generally unrelated to a centralized content provider site. Users on the video site www.youtube.com do not have to register, but can provide feedback on the content, like rating based upon like/dislike of the content. Users of other information-based sites, like www.craigslist.com also typically do not register to view or access the information; however, they can provide feedback. Additionally, the content creators of the information being posted or hosted on the craigslist.com site typically provide contact information so that any user can follow-up with them (items for sale include information provided by the content creator, including contact information). However, in any case, the users that provide the feedback are not known by the content providers, and are not organized formally, i.e., they are not members having unique identifiers, including profiles and contact information, including content preferences.

Thus there remains a need for a system and methods that provide for digital content creation and upload through a managed website for providing network-based access to authorized users who pay for predetermined rights and who can create and join groups with other authorized users based upon user interests relating to the content.

### SUMMARY OF THE INVENTION

A first aspect of the present invention is to provide a method for providing creating and joining groups in a network relating to promoting digital media for distribution to users over the network including the steps of: providing a digital representation of media (DRM) available for distribution over a network, wherein the DRM is provided in a digitally recorded format (DRF) and transmittable remotely to a network portal for upload to a website; providing the DRM in DRM unit(s) stored remotely at a data storage site(s) and available for selective download by authorized users of the network who access website remotely and who are associated with an active account through the website; wherein the DRF is provided by a creating user having rights to the DRF; and wherein the DRM downloads are provided to authorized users based upon their respective accounts; and providing a user-selected option for joining an organized, virtual group of authorized users having predetermined interests in select content being provided through the website, and wherein promotional material associated with DRM content available through the website is provided to the authorized users within a related group.

Preferably, the predetermined interests are based upon a user profile and/or based upon a content index having information about the DRM units accessed by the authorized user. wherein the predetermined interests are updated automatically based upon changes to the content index.

A second aspect of the present invention is to provide method for promoting digital media for distribution to users over a network using personalized notification to users including the steps of: providing a digital representation of media (DRM) available for distribution over a network, wherein the DRM is provided in a digitally recorded format (DRF) and transmittable remotely to a network portal for upload to a website; providing the DRM in DRM unit(s) stored remotely at a data storage server(s) and available for selective access by authorized users of the network who access website remotely and who are associated with an active account through the website; wherein the DRF is provided by a creating user having rights to the DRF; and wherein the DRM access is provided to authorized users based upon authorized user selection of content via a content index associated with an authorized user in an interactive graphic user interface (GUI); and providing personalized notification to authorized users within at least one user group including promotional material based upon the user group interests for the DRM that is automatically associated with the DRM available for access at the website. In one embodiment, the personalized notification including promotional support for the DRM that is automatically associated with the DRM available for access at the website, and geography-specific information about activities related to each user's content index, wherein the information is provided to the authorized users based upon their geographic location indication, thereby providing an automated promotion and distribution system based upon user groups for digital media through the network.

Another aspect of the present invention is to provide a method for providing automated alerts in connection with promoting digital media for distribution to users within predetermined user groups that are related to individual authorized user interests based upon user profiles and/or the content index for each user, the method being functional and operating over a network including the steps of: providing a digital representation of media (DRM) available for distribution over a network, wherein the DRM is provided in a digitally recorded format (DRF) and transmittable remotely to a network portal for upload to a website; providing the DRM in DRM unit(s) stored remotely at a data storage site(s) and available for selective download by authorized users of the network who access website remotely and who are associated with an active account through the website; wherein the DRF is provided by a creating user having rights to the DRF; and wherein the DRM downloads are provided to authorized users based upon a predetermined number of simultaneous playback units of each DRM unit; and providing automatic alerts directly to the authorized user(s) including promotional support for the DRM that is automatically associated with the DRM available for access at the website, thereby providing an automated promotion and distribution system for digital media through the network.

Thus, the present invention provides automated alerts or notification to authorized users within user communities or groups including promotion of the DRM relevant to each group, wherein the DRM is maintained remotely through the website through which the user accesses the DRM content.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a flow diagram of the method according to one embodiment of the present invention.

FIG. 2 is a schematic diagram of the system supporting the methods of use, in accordance with an embodiment of the present invention.

FIG. 3 is a schematic diagram illustrating user community or group connectivity according to one embodiment of the present invention.

### DETAILED DESCRIPTION

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

The present invention provides a system and methods that provide for a method for creating and joining groups within a community of authorized users having an authorized user account with a network-based system that provides a digital representation of media (DRM) available for distribution over a network, wherein the DRM is provided in a digitally recorded format (DRF) and transmittable remotely to a network portal for upload to a website; providing the DRM in DRM unit(s) stored remotely at a data storage site(s) and available for selective download by authorized users of the network who access website remotely and who are associated with an active account through the website; wherein the DRF is provided by a creating user having rights to the DRF; and wherein the DRM downloads are provided to authorized users based upon a predetermined number of simultaneous playback units of each DRM unit; and providing geographic alerts to authorized users including promotional material for the DRM that is automatically associated with the DRM available for access at the website, thereby providing an automated promotion and distribution system for digital media through the network.

In another embodiment of the present invention provides a method for creating and joining groups of authorized users having at least one common interest related to digital media.

The method for promoting digital media for distribution to users over a network using personalized notification to users within at least one group includes the steps of: providing a digital representation of media (DRM) available for distribution over a network, wherein the DRM is provided in a digitally recorded format (DRF) and transmittable remotely to a network portal for upload to a website; providing the DRM in DRM unit(s) stored remotely at a data storage server(s) and available for selective access by authorized users of the network who access website remotely and who are associated with an active account through the website; wherein the DRF is provided by a creating user having rights to the DRF; and wherein the DRM access is provided to authorized users based upon authorized user selection of content via a content index associated with an authorized user in an interactive graphic user interface (GUI); and providing personalized notification to authorized users, the personalized notification including promotional support for the DRM that is automatically associated with the DRM available for access at the website, and geography-specific information about activities related to each user's content index, wherein the information is provided to the authorized users based upon their geographic location indication, thereby providing an automated promotion and distribution system for digital media through the network.

Also, the present invention provides a method for providing automated alerts in connection with promoting digital media for distribution to users over a network including the steps of: providing a digital representation of media (DRM) available for distribution over a network, wherein the DRM is provided in a digitally recorded format (DRF) and transmittable remotely to a network portal for upload to a website; providing the DRM in DRM unit(s) stored remotely at a data storage site(s) and available for selective download by authorized users of the network who access website remotely and who are associated with an active account through the website; wherein the DRF is provided by a creating user having rights to the DRF; and wherein the DRM downloads are provided to authorized users based upon a predetermined number of simultaneous playback units of each DRM unit; and providing automatic alerts directly to the authorized user(s) including promotional support for the DRM that is automatically associated with the DRM available for access at the website, thereby providing an automated promotion and distribution system for digital media through the network.

Preferably, the methods further include targeted or focused promotion, which may include real-time alerts or personalized notifications, to at least one group of authorized users, including providing automatic electronic alerts relating to promoting digital media and/or related events, performances, interactive sessions with creating users or artists, etc.

The alerts are preferably automatic and provided by the same website that is managing the digital content creation, upload, distribution and promotion through network-based access to authorized users who pay for predetermined rights that allow for use of the content by the authorized user. In one embodiment, the authorized user has a user account and profile that provides for simultaneous use of the content on a multiplicity of devices, without having to repurchase access to the same content to address the longstanding, unmet needs within the entertainment industry to address interests of consumers, artists and authors, and the entity managing and securing authorized, legal rights to distribute and sell access to that digital content, on demand by authorized users. This multiple-device distribution arrangement provides for unique promotional opportunities to the user, based upon content use and profile, including promotion that relates to specific devices. Advantageously, the alerts or notification system to authorized users leverages the multiple- and/or mobile device access and content distribution; since the devices communicate with the website and also have a geographic indicator of location at the time of access, the system can personalize notification to the authorized user automatically according to device geography. In one case, the user registers devices through the website with the authorized user account and/or profile; this profile can be updated by the user. Only devices registered to the user can access the content via the user's account and content index that is specific to that user. Those registered devices are preferably operable to interactively communicate with the site to transmit information on geographic location and then receive geographic-specific information that is also preferably customized to the user preferences based upon the user profile, account, and/or content index (and combinations thereof).

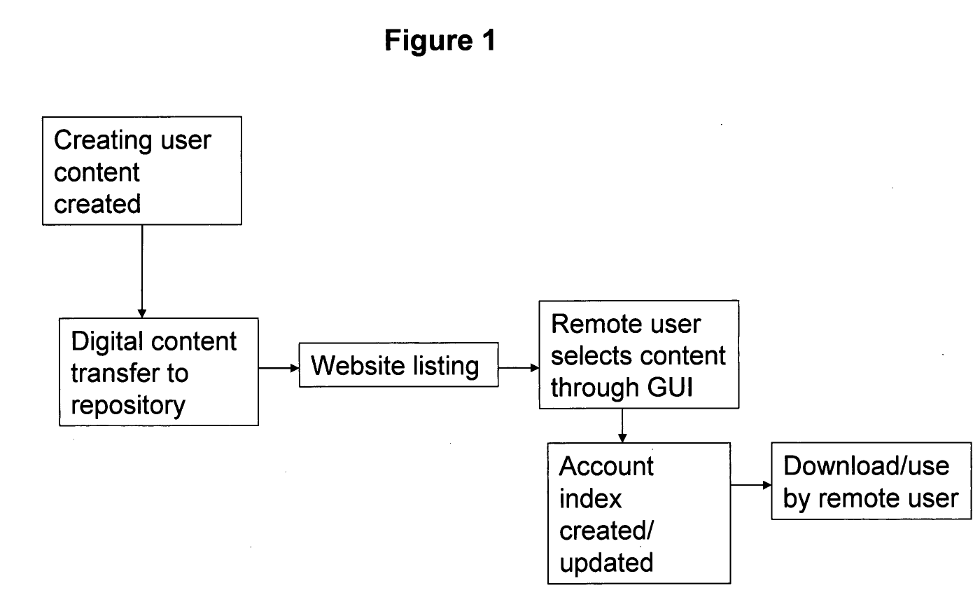

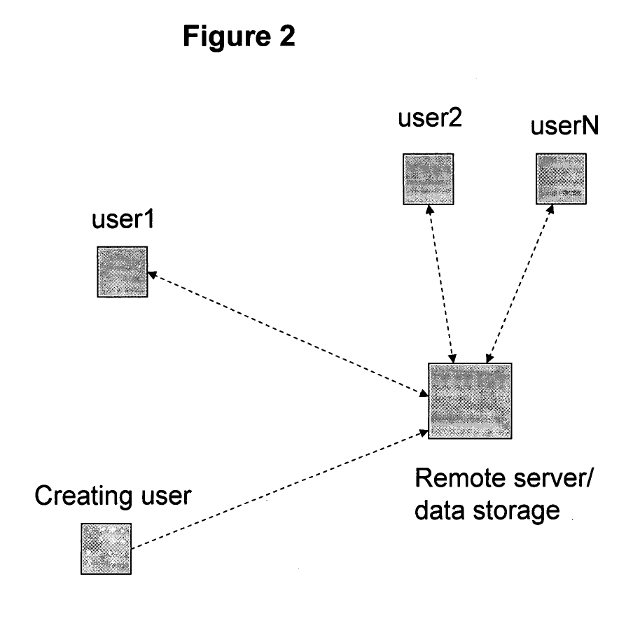

Referring now to the drawings in general, the illustrations are for the purpose of describing the basic content creation, upload, and distribution aspects of the invention and are not intended to limit the invention thereto. As best seen in FIG. 1, a flow diagram is provided for user access to the system, which is shown in the schematic representation of FIG. 2. FIG. 1 illustrates steps for a creating user to create content, transfer the digital version of the content to a data input or repository for storage, indexing, and access, the website generating a listing or index associated with that content, including categorization, a user selecting content and an automatic generation of an account content index, and then the user using the content, such as via download of a digital copy of the content. FIG. 2 illustrates user1, user2, . . . userN interacting with a remote server or data repository through network interaction; also, a creating user accessing the remote server or data repository for uploading digital content is illustrated. The geographic location and personalized information or alerts are communicated between the user/device(s) and the remote server via the network as illustrated.

The present invention provides a method for providing creating and joining groups in a network relating to promoting digital media for distribution to users over the network including the steps of: providing a digital representation of media (DRM) available for distribution over a network, wherein the DRM is provided in a digitally recorded format (DRF) and transmittable remotely to a network portal for upload to a website; providing the DRM in DRM unit(s) stored remotely at a data storage site(s) and available for selective download by authorized users of the network who access website remotely and who are associated with an active account through the website; wherein the DRF is provided by a creating user having rights to the DRF; and wherein the DRM downloads are provided to authorized users based upon their respective accounts; and providing a user-selected option for joining an organized, virtual group of authorized users having predetermined interests in select content being provided through the website.

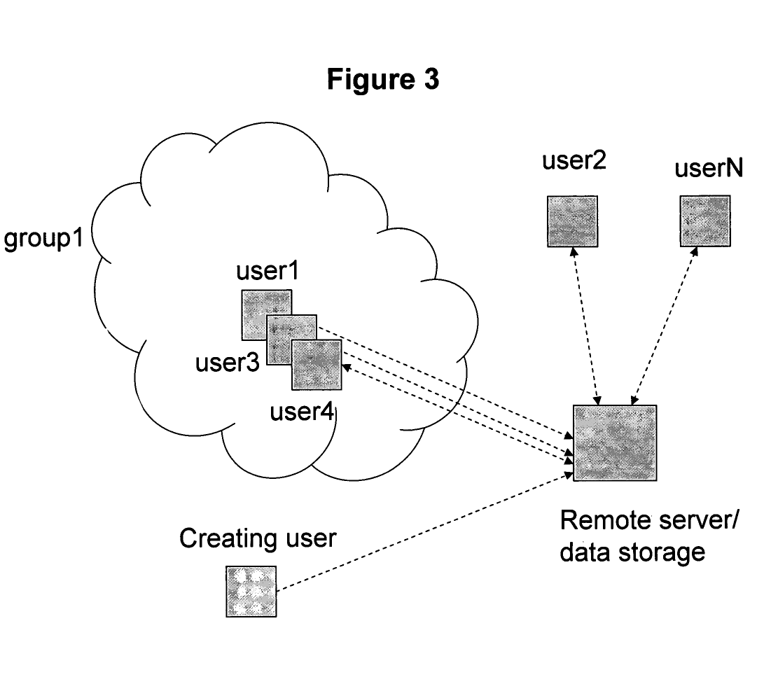

Preferably, in methods according to the present invention, the predetermined interests for users within any group are based upon a user profile and/or a content index having information about the DRM units accessed by the authorized user; additionally or alternatively, the predetermined interests are based upon a group content index that is formed from the inclusion of the content index for all users within the group. Also, the predetermined interests are updated automatically based upon changes to the content index for any user and/or updated by the authorized user at will, through the network by making indications or selections on the user interface of the website. FIG. 3 provides a schematic that illustrates the relationship of authorized users within groups having at least one common interest related to user profile and/or content index for each user.

Preferably, the present invention further provides for promotional material associated with DRM content available through the website to be provided to the authorized users within a related group, including geographic alerts to authorized users within at least one user group including promotional material based upon the user group interests for the DRM that is automatically associated with the DRM available for access at the website.

The present invention includes method steps for providing digital media for distribution to users associated with groups over a network, and providing promotion for that digital media to the users, including the steps of providing a digital representation of media (DRM) available for distribution over a network, wherein the DRM is provided in a digitally recorded format (DRF) and transmittable remotely to a network portal for upload to a website; and providing the DRM in DRM unit(s) stored remotely at a data storage site(s) and available for selective download by authorized users of the network who access website (through the network portal) remotely and who are associated with an active account through the website; wherein the DRF is provided by a creator of the DRF; the creating user agreeing to or providing promotional materials for the DRM, preferably also in a DRF format; and wherein the DRM downloads are provided to authorized users based upon a predetermined number of simultaneous playback units of each DRM unit. In one embodiment, preferably, the DRM downloads are repeatedly downloadable based upon a predetermined number of downloads per DRM unit, which is associated with each authorized user, not based upon the number of devices to which the DRM is downloaded. Importantly, in sharp contrast to prior art, the DRM download does not affect the DRM availability to the authorized user, because according to the present invention, the DRM or the actual content is stored remotely from the authorized user and therefore the content remains with the website, and is actually not transferred to the user. A digital copy is downloaded by the user onto any device owned or operated by the user, in exchange for a license to use or play the DRM in accordance with the license rights granted.

Significantly, with the methods and the system of the present invention, in one embodiment the user has completely remote access to DRM that is maintained by someone other than the authorized user. Also, the user has access to download and play the DRM units based upon actual simultaneous play of any DRM unit, regardless of the format or type of device on which the DRM units are played or accessed by the user. So then if the user is traveling anywhere on the globe but accessing the network from a multiplicity of access devices, including but not limited to mobile phones, computers, PDAs, MP3 players, audio and/or visual players, DVRs, and the like, and combinations thereof, then the user still has access to any DRM units within that user's authorized portfolio (or collection, family, group, database, depository, repository) of DRM units, which are available for selective download and play, or direct experience (including audio and/or video) through the website portal, accessed by the authorized user through a network such as the world wide web or Internet.

The user creates their own portfolio of content in DRM, including but not limited to music, movies, audio books, podcasts, radio, news, broadcasts (stored), and the like, and combinations thereof. The portfolio index of that content is stored for each user, while the content distributor or provider stores only one digital copy of each DRM, thereby creating a singular or primary library that is remotely stored from any user or user's device(s). The portfolio index indicates which of the primary library the user has rights to access simultaneously, regardless of the device on which the user wants to access or download the content. Users can therefore access the content from any device, at any time, any place that is network accessible. The predetermined number of DRM units accessible by a single authorized user for simultaneous use is established to be between one (1) and N, where N is provided to ensure flexibility of enjoyment and use by an authorized user, but N is less than unlimited in order to ensure that the system and methods of the present invention are used, and therefore to prevent counterfeiting, illegal access or downloading, which ensures appropriate compensation to the authors, artists, and distribution entity.

The content index may automatically qualify any authorized user for inclusion within a group within the user community associated with the website. Additionally, authorized users can apply for membership to a group, and if that group is pre-existing, then the user may automatically join the group, or the group members may vote to include the applicant, depending upon the type of group.

A new group may be created by any authorized user, provided that a previously established or created group does not already exist for the same interests. Guidelines may be established in advance and provided uniformly to all authorized users, or in the case of tiered levels of authorized users, there may be corresponding variations in rules for groups, and in predetermined exclusivity for those groups.

An authorized user is permitted to join more than one group at any time, provided that the user meets group requirements. Examples of the types of requirements for joining a group include: having an interest in a specific genre of music or video, having purchased a specific amount of a certain type of genre of music or video, having an interest in a specific artist, having purchased a music or video from a specific artist, having participated in a specific event, having interest in a specific instrument, possessing specific skills (writing, performing, recording, marketing, etc.), having performed at a specific venue, having at one time watched any performance at a specific venue, having a specific combination of characteristics or interests (for example a group of American artists planning an Asian tour communicating with each other and with American artists having completed and Asian tour). Groups may be established by the owners of the web site or by the participants themselves. Guidelines may be established by the owners of the web site, and participants may further create their own rules for the groups. Communications within a group may be visible to all members of the group or to some subset.

In the business model and methods of doing business for digital media content creation, upload, distribution, and promotion according to the present invention, including the automated alerts that are personalized to the user, and to at least one user group within the authorized user community associated with the website, including geography-specific alerts, wherein the authorized users pay a fee for access to the content, and preferably, also pay a fee for predetermined promotional features, including the geography-based activities, such as performances, interviews, chats, and/or interactive sessions with the creating users or artists. Preferably, these alerts and promotions are provided in a customized manner to users based upon the user profile, account, and/or content index so that the alerts and promotions are attractive to the user. These additional activities, performances, or dynamic interactive sessions (live, in-person, or online) may be exclusive or private to the authorized users whose profile is related thereto; they may be optional, and may also be associated with a fee. Revenue sharing of this fee with the creating user may be the same or may be modified from the distribution arrangement based upon DRM units and other licensing. Other promotional features including alerts are provided on a non-fee basis, including but not limited to promotional offers based upon past purchases, promotional offers based upon the authorized user's content index, promotional offers based upon the authorized user's account and/or user profile or other data related to the user's interaction with the website. The user can opt in or opt out of a group at any time; and therefore would correspondingly opt in or out promotional offers provided to the group at any time, by indicating the user preference on the website. The DRM units and promotional features, including alerts, are either preselected, or selected by the authorized user based upon an alert or invitation, are documented in that authorized user's portfolio index, which references which portions of the primary library that authorized user has rights to access, and which promotional features the user has opted in or opted out of. In one embodiment, for each paid content unit, or DRM unit, and promotional features, the authorized user pays a predetermined amount that is significantly less than other web-based models.

The authorized user group may also selectively indicate a geographic location that is specific to that group, in advance, such as before travel to another city, state, or country, or to the space station. Preferably, the authorized user group members can download for play for air travel and receive alerts on both departing and arriving ends of the trip.

A portfolio index may be optionally shared with other authorized users within a group and/or across group, preferably for a fee. By way of example to illustrate this case, and not by way of limitation of the scope of the invention, a family of four may elect to pay for 2, 3, or 4 concurrent users of the database allowing that number of users to access any combination of works simultaneously. So a family with a three-user license may be playing song A in a car, song A in the kitchen, and movie B in the den at the same time since they have paid for three people to access the database simultaneously. Furthermore, distinctions may be identified for different types of users allowing them to be charged using differing methods. For example, a movie theater may download or access a movie to be run for a number of people to view simultaneously; also, they may opt in or opt out of promotional material for other films (previews and advertisements). The artist/owner would then be paid a fee based on the number of people viewing the movie. Distinctions could be made for other types of users including schools, radio stations, dance clubs, etc where the fee could be nothing, based on number of viewers/listeners, or based on the capacity of the venue.

Preferably, the DRF for the content and promotional features including alerts are input directly by the creator, artist, agent, owner or authorized creative entity (hereinafter “creating user”) for distribution through the website, and may be provided in tiered or preferred access to predetermined groups. In one embodiment, the DRF is created by the creator or creating user at a media station having direct connectivity for upload to the website. In another embodiment, the creating user has a pre-digitally recorded copy of the content ready-to-distribute. The creating user, in any case, makes a certification that they are the true author or owner of the content they intend to provide for digital upload and distribution through the site. Additionally, the creating user has the sole decision as to what content is uploaded, including digital media content and promotional material content.

Optionally, there is a review panel associated with each authorized user group that provides for screening of content based upon the normal preferences for that group or subset within the community, including promotional material, for rating and/or quality purposes. The review panel may include a limited number of authorized users for the group (designated or representative users) or may include all active members of the group, and preferably active users who can provide a democratic voice or at least a representative cross-section of the users to indicate what position the user base may be. The review panel may further have the authority to remove members from the group or to place them on inactive group status for example based upon time of inactivity with the group or based on violation or potential violation of the groups rules. This may be further subdivided by geography, religion, language, etc.

Certain modifications and improvements will occur to those skilled in the art upon a reading of the foregoing description. By way of example, technological advancements in media may include a form other than “digital” media; a variety of methods may be created to “download” or “access” media; numerous hand held, microchip, contact lens, ear piece, or implanted devices may be utilized to view and hear media or send the information directly to the brain; other methods of sharing a database or indexing that database could be utilized, etc. Additionally, the content index may relate to items beyond digital media, for example, purchases of products or services. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the following claims.

What is claimed is:

1. A method for providing creating and joining groups in a network relating to promoting digital media for distribution to users over the network comprising the steps of:
providing a digital representation of media (DRM) available for distribution over a network, wherein the DRM is provided in a digitally recorded format (DRF) and transmittable remotely to a network portal for upload to a website;
providing the DRM in DRM unit(s) stored remotely at a data storage site(s) and available for selective download by authorized users of the network who access website remotely and who are associated with an active account through the website;
wherein the DRF is provided by a creating user having rights to the DRF; and
wherein the DRM downloads are provided to authorized users based upon their respective accounts; and
providing a user-selected option for joining an organized, virtual group of authorized users having at least one common predetermined interest in select content being provided through the website.

2. The method of claim 1, wherein the predetermined interests are based upon a user profile.

3. The method of claim 1, wherein the predetermined interests are based upon a content index having information about the DRM units accessed by the authorized user.

4. The method of claim 1, wherein the predetermined interests are based upon geography-based information relating to the user.

5. The method of claim 1, wherein the predetermined interests are updated automatically based upon changes to the content index.

6. The method of claim 1, wherein the predetermined interests are updated by the authorized users within each group.

7. The method of claim 1, wherein promotional material associated with DRM content available through the website is provided to the authorized users within a related group.

8. The method of claim 1, wherein the geographic alerts are related to a content index for associated with the DRM selected for use by the authorized users within each group.

9. The method of claim 1, wherein the geographic alerts include geography-specific activities in which the authorized user may participate, including private or exclusive performances, showings or interactive sessions with the creating user(s) of select DRM content.

10. The method of claim 1, wherein the geographic alerts are provided to authorized user(s) based upon the geographic location of the preponderance of authorized user members within each of the groups.

11. The method of claim 1, wherein the promotional material is associated with a shared content index for the group.

12. The method of claim 1, wherein the promotional material is associated with trends in the content index for each group.

13. The method of claim 1, wherein the promotional support includes marketing collateral materials for web-based advertising or promotion of the DRM that is customized for at least one target group.

14. A method for promoting digital media for distribution to users over a network using personalized notification to users comprising the steps of:
providing a digital representation of media (DRM) available for distribution over a network, wherein the DRM is provided in a digitally recorded format (DRF) and transmittable remotely to a network portal for upload to a website;
providing the DRM in DRM unit(s) stored remotely at a data storage server(s) and available for selective access by authorized users of the network who access website remotely and who are associated with an active account through the website;
wherein the DRF is provided by a creating user having rights to the DRF; and
wherein the DRM access is provided to authorized users based upon authorized user selection of content via a content index associated with an authorized user in an interactive graphic user interface (GUI); and
providing personalized notification to authorized users within at least one user group including promotional material based upon the user group interests for the DRM that is automatically associated with the DRM available for access at the website.

15. The method of claim 14, wherein each group has a shared group content index that includes all content index contents for each group member.

16. The method of claim 14, further including the step of providing group-personalized notification including promotional support for the DRM that is automatically associated with the DRM available for access at the website.

17. The method of claim 15, further including the step of automatically updating the promotional support and based upon updates to the group content index.
